(19) United States
(12) Patent Application Publication
(10) Pub. No.: US 2014/0157157 A1
(43) Pub. Date: Jun. 5, 2014

(54) INFORMATION PROCESSING APPARATUS, CONTROL METHOD OF INFORMATION PROCESSING APPARATUS AND COMPUTER-READABLE MEDIUM

(71) Applicant: Kabushiki Kaisha Toshiba, Tokyo (JP)

(72) Inventor: Hideki Yoshida, Tachikawa-shi (JP)

(21) Appl. No.: 13/914,070

(22) Filed: Jun. 10, 2013

(30) Foreign Application Priority Data
Nov. 30, 2012 (JP) 2012-263066

(51) Int. Cl. G06F 3/0484

(52) U.S. Cl. CPC G06F 3/0484
USPC 715/765

(57) ABSTRACT

An information processing apparatus includes a display, a touch panel provided on the display, a storage, a connection detector, and a controller. The storage stores plural kinds of software key arrangement information. The connection detector detects whether or not an input device in which mechanical keys are arranged is connected, and outputs a connection detection result. The controller determines arrangement information to be used among the plural kinds of software key arrangement information according to the connection detection result which is output from the connection detector, and causes the display to display software keys based on the determined arrangement information.

### CROSS-REFERENCE TO RELATED APPLICATION(S)

This application is based upon and claims the benefit of priority from Japanese Patent Application No. 2012-263066, filed Nov. 30, 2012; the entire contents of which are incorporated herein by reference.

### FIELD

Embodiments described herein relate to an information processing apparatus, a control method of an information processing apparatus, and a computer-readable medium.

### BACKGROUND

Conventionally, in information processing apparatus such as personal computers, a keyboard in which mechanical keys are arranged is used for character input etc. On the other hand, in recent years, such information processing apparatus as smartphones and tablet terminals have increasingly come to use a virtual keyboard in which virtual keys are displayed on a touch screen and a user is allowed to input characters etc. by making touch manipulations on them.

The virtual keyboard has an advantage that it does not require a fixed space in a cabinet because it is displayed on a touch screen only when character input is necessary. The virtual keyboard is also advantageous in that the key arrangement can be changed according to a use situation or a user taste.

On the other hand, the virtual keyboard has a problem that a user tends to push a key that is located adjacent to an intended key because a user cannot feel contact to a keytop unlike with mechanical keys. Another problem of the virtual keyboard is that a user has difficulty recognizing whether or not the user has pushed a key successfully because, unlike with mechanical keys, he or she receives no feedback in response to the key push.

### BRIEF DESCRIPTION OF THE DRAWINGS

FIG. 1 shows the configuration of an information processing apparatus according to a first embodiment.

FIG. 2 shows an example display on a touch screen in the case where only the information processing apparatus is used.

FIG. 3 shows the electrical configuration of the information processing apparatus according to the first embodiment.

FIG. 4 shows an example display that is made on the touch screen when a shift key (HW key) is pushed.

FIG. 5 shows an example display that is made on the touch screen when the symbol key arrangement has been changed.

FIG. 6 is a flowchart of an SW key mapping table switching process.

FIG. 7 shows the electrical configuration of an information processing apparatus according to a second embodiment.

FIG. 8 shows an example display which is made on the touch screen when a keyboard is connected to the information processing apparatus.

FIG. 9 is a flowchart of an SW key mapping table switching process.

FIG. 10 shows the electrical configuration of an information processing apparatus according to a third embodiment.

FIG. 11 is a flowchart of an SW key mapping table switching process.

### DETAILED DESCRIPTION

According to one embodiment, an information processing apparatus includes a display, a touch panel provided on the display, a storage, a connection detector and a controller. The storage is configured to store a plurality of kinds of software key arrangement information. The connection detector is configured to detect whether or not an input device in which mechanical keys are arranged is connected, and to output a connection detection result. The controller is configured to determine arrangement information to be used among the plurality of kinds of software key arrangement information according to the connection detection result which is output from the connection detector, and to cause the display to display software keys based on the determined arrangement information.

Various Embodiments will be described hereinafter with reference to the accompanying drawings.

### Embodiment 1

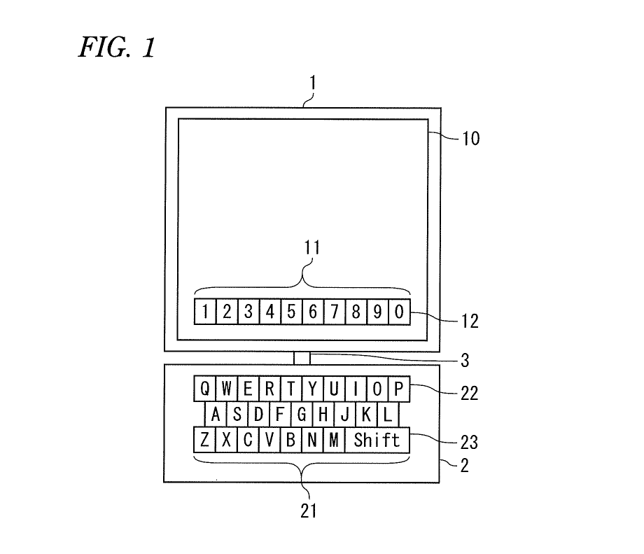

First, the configuration of an information processing apparatus 1 according to a first embodiment will be described with reference to FIGS. 1-3.

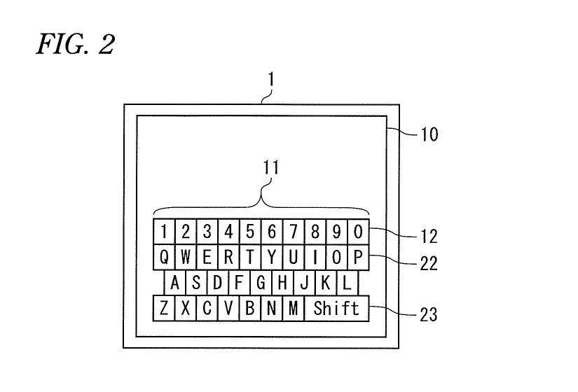

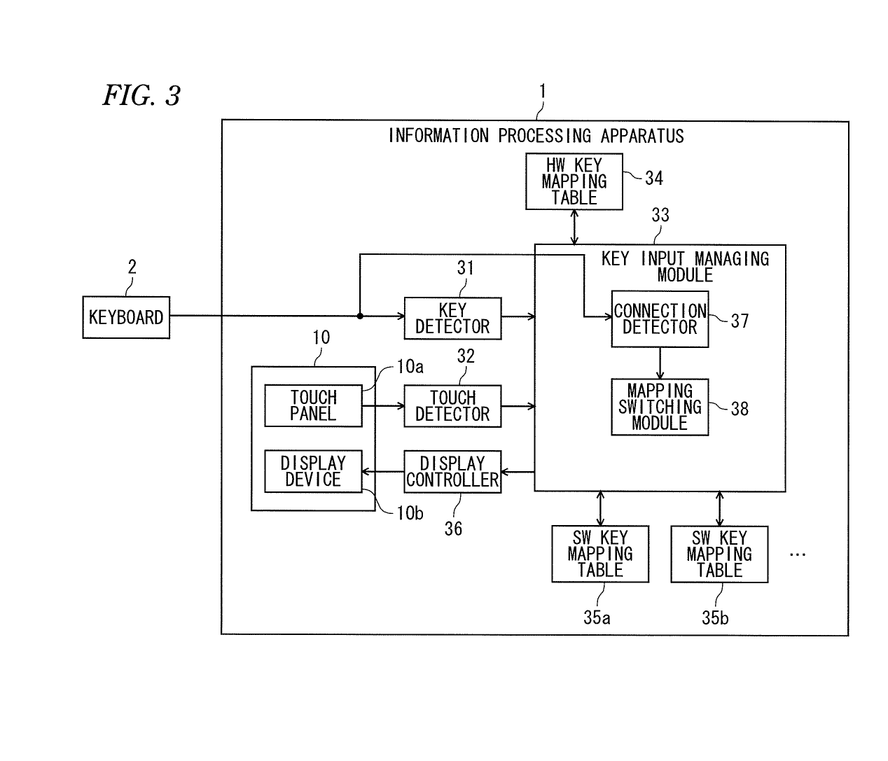

FIG. 1 shows the configuration of the information processing apparatus 1 according to the first embodiment. FIG. 2 shows an example display on a touch screen 10 in the case where only the information processing apparatus 1 is used. FIG. 3 shows the electrical configuration of the information processing apparatus 1 according to the first embodiment.

As shown in FIG. 1, the information processing apparatus 1 is an information terminal such as a smartphone or a tablet terminal and a keyboard 2 for character input is attached to it via a connection module 3 in a detachable manner The connection module 3 is a wired connection module using USB, for example. However, the invention is not limited to such a case and a wireless connection module may be used which uses Bluetooth (registered trademark), for example.

The information processing apparatus 1 has the touch screen 10 which consists of a touch panel 10a (see FIG. 3) and the screen of a display device 10b (see FIG. 3) which is a display such as a liquid crystal display or an organic EL display. Virtual keys (hereinafter referred to as SW keys (software keys)) 11 are displayed on the touch screen 10, and characters etc. can be input by making touch manipulations on the SW keys 11. In this embodiment, the SW keys 11 are plural numeral keys 12 which are low in use frequency.

The keyboard 2 as an input device has mechanical keys (hereinafter referred to HW keys (hardware keys) 21 which are, in this embodiment, plural alphabet keys 22 and a shift key 23 which are high in use frequency.

The manner of key allocation to the touch screen 10 and the keyboard 2 is not limited to the one shown in FIG. 1 because the keys that are high in use frequency and the keys that are low in use frequency vary depending on the user or the use situation. For the sake of simplicity of description, only a minimum necessary number of keys are shown in FIG. 1; actually, additional SW keys 11 and HW keys 21 such as symbol keys and function keys are also arranged on the information processing apparatus 1 and the keyboard 2.

The information processing apparatus 1 can be used singly. Where the information processing apparatus 1 is used singly, as shown in FIG. 2 numeral keys 12, alphabet keys 22, and a shift key 23 are displayed as SW keys 11 on the touch screen 10.

As shown in FIG. 3, the information processing apparatus 1 is equipped with, in addition to the touch screen 10, a key detector 31, a touch detector 32, a key input managing module 33, a HW key mapping table 34, plural SW key mapping tables 35a, 35b, etc., and a display controller 36.

The key input managing module 33 has a connection detector 37 for detecting whether or not the keyboard 2 is connected to the information processing apparatus 1 and a mapping switching module 38 for switching the SW key mapping table to be referred to among the SW key mapping tables 35a, 35b, etc. Each of the function blocks of the key input managing module 33 may be implemented as a program.

When an HW key of the keyboard 2 is pushed, the key detector 31 detects code information corresponding to the pushed HW key 21 and outputs it to the key input managing module 33. Pieces of code information and pieces of character information are stored in the HW key mapping table 34 so as to be correlated with each other.

When receiving code information from the key detector 31, the key input managing module 33 refers to the HW key mapping table 34 and reads character information corresponding to the received code information from it. The read-out character information is displayed on the touch screen 10 under the control of the display controller 36.

When an SW key 11 displayed on the touch panel 10a of the touch screen 10 is pushed, the touch detector 32 detects coordinate information and level information corresponding to the pushed SW key 11 and outputs them to the key input managing module 33.

Arrangement information of the SW keys 11 in which pieces of coordinate information on the touch screen 10 and pieces of character information are correlated with each other is contained in each of the SW key mapping tables 35a, 35b, etc. which are stored in a storage. The SW key mapping tables 35a, 35b, etc. are different kinds of tables for display of the SW keys 11 on the touch panel 10. As described later, switching is made among the SW key mapping tables 35a, 35b, etc. depending on whether or not the keyboard 2 is connected to the information processing apparatus 1.

The connection detector 37 detects whether or not the keyboard 2 is connected to the information processing apparatus 1, and outputs a connection detection result to the mapping switching module 38.

The mapping switching module 38 as a controller switches the SW mapping table to be referred to among the SW key mapping tables 35a, 35b, etc. according to the connection detection result supplied from the connection detector 37. That is, the mapping switching module 38 determines arrangement information to be used among the plural pieces of arrangement information, and performs a control for causing the display device 10b to display SW switches 21 on the basis of the determined arrangement information.

More specifically, assume that, for example, the SW key mapping table 35a is a keyboard connection table for display of only the numeral keys 12 (see FIG. 1) on the touch screen 10 and the SW key mapping table 35b is a keyboard non-connection table for display of the numeral keys 12, the alphabet keys 22, and the shift key 23 (see FIG. 2) on the touch screen 10.

If connection of the keyboard 2 to the information processing apparatus 1 is detected by the connection detector 37, the mapping switching module 38 switches the table to be referred to the SW key mapping table 35a. The SW key mapping table 35a is used for key display on the touch screen 10 under the control of the display controller 36. As a result, while the keyboard 2 is connected to the information processing apparatus 1, only the numeral keys 12 are displayed on the touch screen 10 in the manner shown in FIG. 1.

On the other hand, if disconnection of the keyboard 2 to the information processing apparatus 1 is detected by the connection detector 37, the mapping switching module 38 switches the table to be referred to the SW key mapping table 35b. The SW key mapping table 35b is used for key display on the touch screen 10 under the control of the display controller 36. As a result, while the keyboard 2 is not connected to the information processing apparatus 1, the numeral keys 12, the alphabet keys 22, and the shift key 23 are displayed on the touch screen 10 in the manner shown in FIG. 2.

When receiving coordinate information and level information from the touch detector 32, the key input managing module 33 reads out character information corresponding to the received coordinate information by referring to the SW key mapping table 35a or 35b depending on a connection state of the keyboard 2. The read-out character information is displayed on the touch screen 10 under the control of the display controller 36.

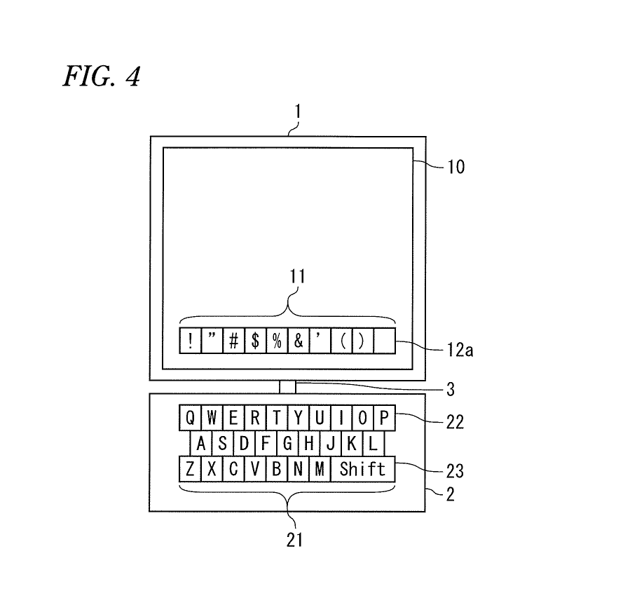

The SW keys 11 may be changed from the numeral keys 12 to symbol keys when the shift key 23 of the HW keys 21 is pushed. FIG. 4 shows an example display that is made on the touch screen 10 when the shift key 21 of the HW keys 21 is pushed.

As shown in FIG. 4, when the shift key 21 is pushed, symbol keys 12a are displayed as the SW keys 11 on the touch screen 10 in place of the numeral keys 12. This is realized in such a manner that the mapping switching module 38 switches the SW key mapping table to be referred to a one corresponding to the key display shown in FIG. 4 which is one of the SW key mapping tables 35a, 35b, etc. Since the shift key 23 is provided on the keyboard 2 as one of the HW keys 21, a manipulation of pushing another key while pushing the shift key can be performed more easily than in a case that the shift key is provided as one of the SW keys 11.

The one, located at the rightmost position in FIG. 4, of the symbol key 12a is not associated with any symbol to be input, the information processing apparatus 1 may abstain from displaying it.

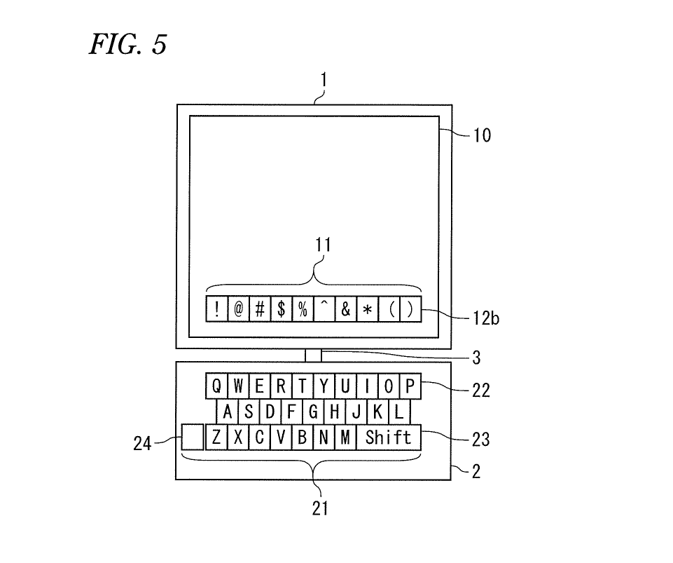

The arrangement of the symbol keys 12a of the SW keys 11 shown in FIG. 4 conforms to the HS arrangement, the symbol key arrangement may be changed according to a use situation or a user. FIG. 5 shows an example display that is made on the touch screen when the symbol key arrangement has been changed.

As shown in FIG. 5, an arrangement alteration key 24 is added to the keyboard 2 as one HW key 21. Alternatively, an arrangement alteration key 24 may be displayed on the touch screen as one SW key 11.

As shown in FIG. 5, when the arrangement alteration key 24 is pushed, symbol keys 12b are displayed on the touch screen 10 so as to conform to the ASCII arrangement in place of the symbol keys 12a. This is realized in such a manner that the mapping switching module 38 switches the SW key mapping table to be referred to a one corresponding to the key display shown in FIG. 5 which is one of the SW key mapping tables 35a, 35b, etc. when the arrangement alteration key 24 is pushed. In this manner, the arrangement of the SW keys 11 can be changed easily.

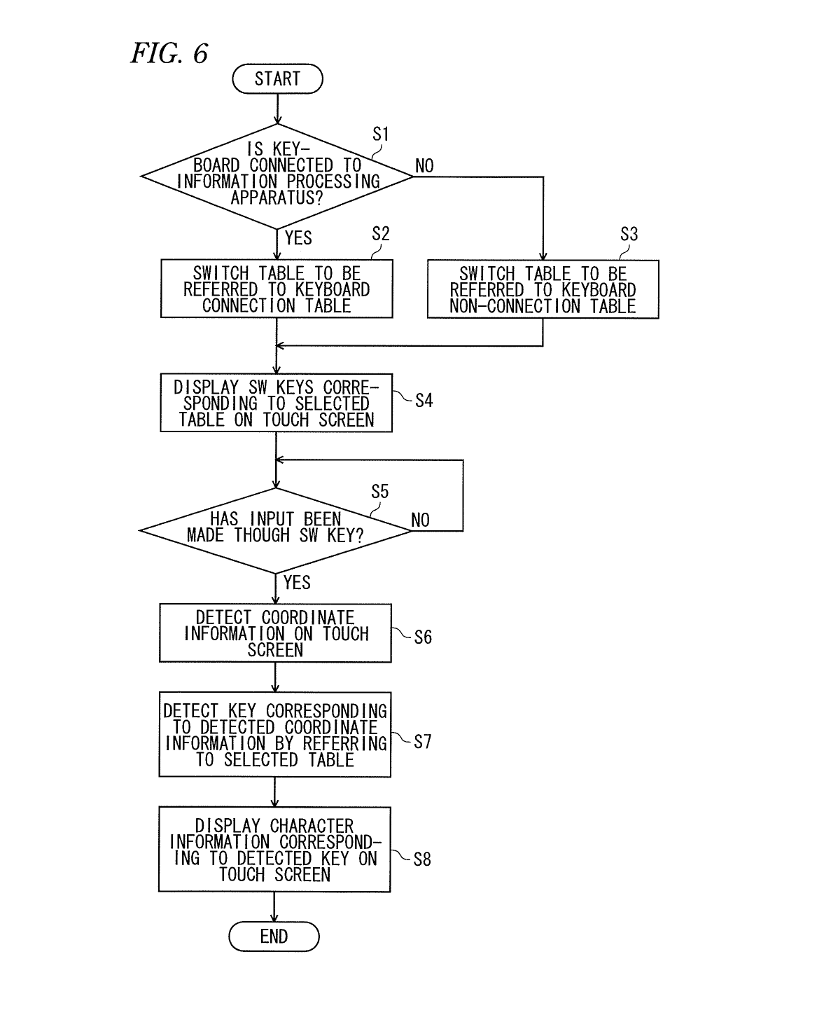

Next, a description will be made of how the above-configured information processing apparatus 1 operates. FIG. 6 is a flowchart of an SW key mapping table switching process.

At step S1, the connection detector 37 detects whether or not the keyboard 2 is connected to the information processing apparatus 1. If it is detected that the keyboard 2 is connected to the information processing apparatus 1 (S1: yes), at step S2 the mapping switching module 38 switches the table to be referred to the keyboard connection table (in the above-described example, SW key mapping table 35a). On the other hand, if it is detected that the keyboard 2 is not connected to the information processing apparatus 1 (S1: no), at step S3 the mapping switching module 38 switches the table to be referred to the keyboard non-connection table (in the above-described example, SW key mapping table 35b). Upon execution of step S2 or S3, at step S4 SW keys 11 corresponding to the thus-selected table are displayed on the touch screen 10 under the control of the display controller 36.

At step S5, the touch detector 32 detects whether or not an input has been made through an SW key 11. If it is detected that no input has been made through an SW key 11 (S5: no), the process returns to step S5. On the other hand, if it is detected that an input has been made through an SW key 11 (S5: yes), at step S6 coordinate information on the touch screen 10 is detected by the touch detector 32. At step S7, the key input managing module 33 detects a key corresponding to the detected coordinate information by referring to the selected SW key mapping table. At step S8, the display controller 36 performs a control so that character information corresponding to the detected key is displayed on the touch screen 10. Then, the process is fmished.

As described above, the information processing apparatus 1 switches the table to be referred to the SW key mapping table 35a or 35b and displays an SW key 11 on the touch screen 10 on the basis of the selected SW key mapping table 35a or 35b. As a result, the information processing apparatus 1 can display, on the touch screen 10, only the keys that are not included in the HW keys 21 of the keyboard 2 when the keyboard 2 is connected to it. Thus, the frequency of use of the SW keys 21 can be reduced.

As such, the information processing apparatus 1 according to this embodiment makes it possible to use software keys properly. Furthermore, in the embodiment, since part of the keys are displayed on the touch screen 10 as SW keys 21, the keyboard 2 need not be provided with all mechanical keys and hence can be miniaturized.

### Embodiment 2

Next, a second embodiment will be described. The second embodiment is directed to an information processing apparatus in which the SW keys to be displayed on a touch screen is switched by detecting not only connection/non-connection of a keyboard but also a keyboard type.

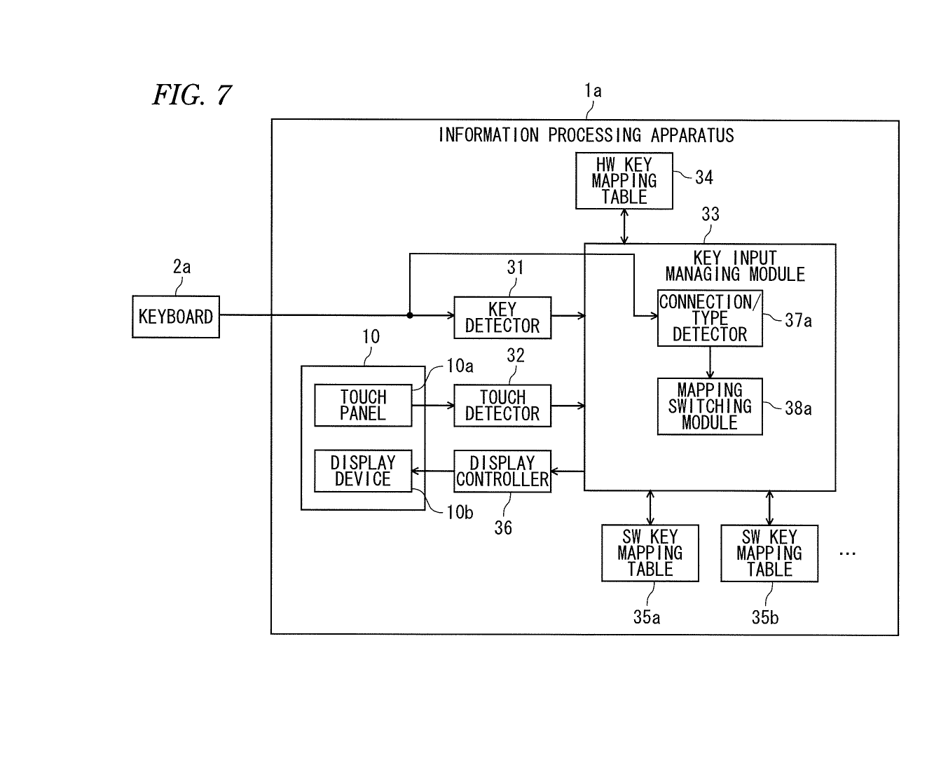

FIG. 7 shows the electrical configuration of an information processing apparatus 1a according to the second embodiment. Sections etc. shown in FIG. 7 having the same ones in FIG. 3 are given the same reference symbols as the latter, and will not be described in detail.

As shown in FIG. 7, the information processing apparatus 1a according to the second embodiment has a connection/type detector 37a and a mapping switching module 38a in place of the connection detector 37 and the mapping switching module 38, respectively, which are used in the first embodiment.

The connection/type detector 37a detects whether or not a keyboard 2a is connected to the information processing apparatus 1a and also detects a type of the keyboard 2a if it is connected to the information processing apparatus 1a. The connection/type detector 37a outputs a detection result(s) to the mapping switching module 38a.

The mapping switching module 38a switches the SW key mapping table to be referred to among the SW key mapping tables 35a, 35b, etc. according to the connection/non-connection-indicative information and the type of the keyboard 2a obtained or detected by the connection/type detector 37a. That is, the mapping switching module 38a switches among the SW key mapping tables 35a, 35b, etc. according to a type of the keyboard 2a (more specifically, a type of the HW keys 21 of the keyboard 2a) and thereby switches a type of SW keys 11 to be displayed on the touch screen 10. Example SW keys 11 which are displayed on the touch screen 10 according to a type of a keyboard 2a will be described below.

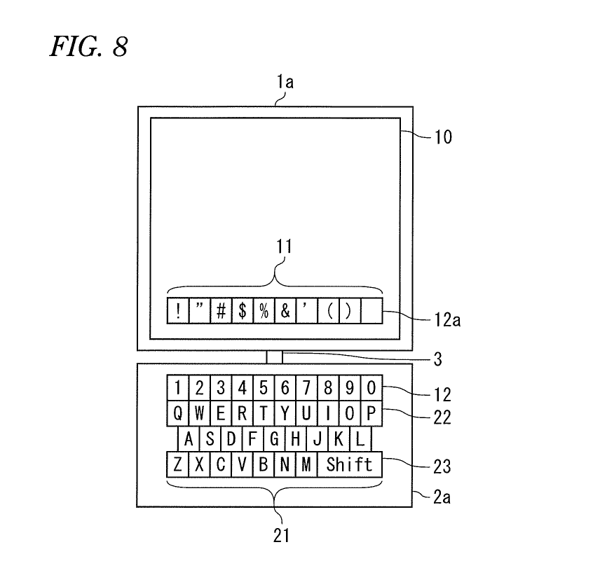

FIG. 8 shows an example display which is made on the touch screen when a keyboard 2a is connected to the information processing apparatus 1a. As shown in FIG. 8, a keyboard 2a which is connected to the information processing apparatus 1a is different from the keyboard 2 shown in FIG. 1 in that numeral keys 12 are added as HW keys 21. That is, the keyboard 2a is provided with, as the HW keys 21, the numeral keys 12, the alphabet keys 22, and the shift key 23.

When this type of keyboard 2a is connected to the information processing apparatus 1a, the information processing apparatus 1a displays, on the touch screen, symbol keys 12a through which no input can be made unless the shift key 23 is pushed. The information processing apparatus 1a may be configured so as no to display any SW keys 11 in the case where the keyboard 2a is provided with keys for all the functions as the HW keys 21.

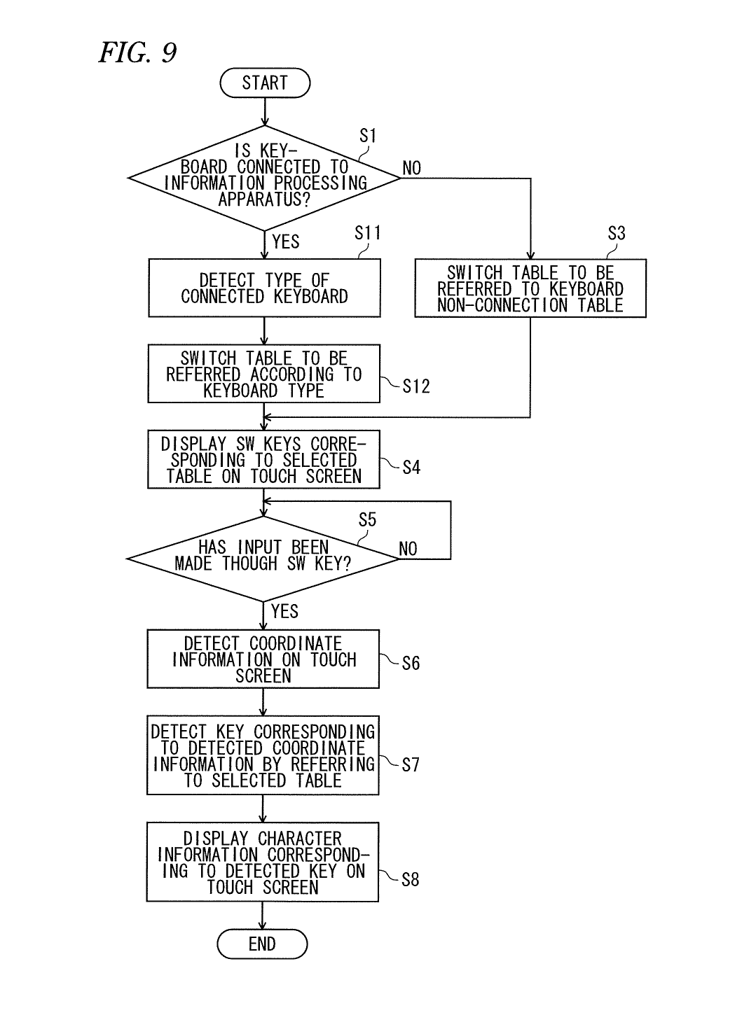

Next, a description will be made of how the above-configured information processing apparatus 1a operates. FIG. 9 is a flowchart of an SW key mapping table switching process. Steps shown in FIG. 9 that have the same steps in FIG. 6 are given the same reference symbols as the latter, and will not be described in detail.

If it is detected that a keyboard 2a is connected to the information processing apparatus 1a (S1: yes), at step S11 the connection/type detector 37a detects a type of the connected keyboard 2a. At step S12, the mapping switching module 38a switches the SW key mapping table to be referred to according to the detected type of the keyboard 2a. The other steps S3-S8 are the same as in the process of FIG. 6.

As described above, the information processing apparatus 1a changes a type of SW switches 11 to be displayed on the touch screen 10 by switching the SW key mapping table to be referred to among the SW key mapping tables 35a, 35b, etc. according to a type of a connected keyboard 2a. As a result, the information processing apparatus 1a according to this embodiment can display optimum SW keys 11 on the touch screen 10 according to the connected keyboard 2a.

### Embodiment 3

Next, a third embodiment will be described. The third embodiment is directed to an information processing apparatus with a SW key mapping table for generating SW keys.

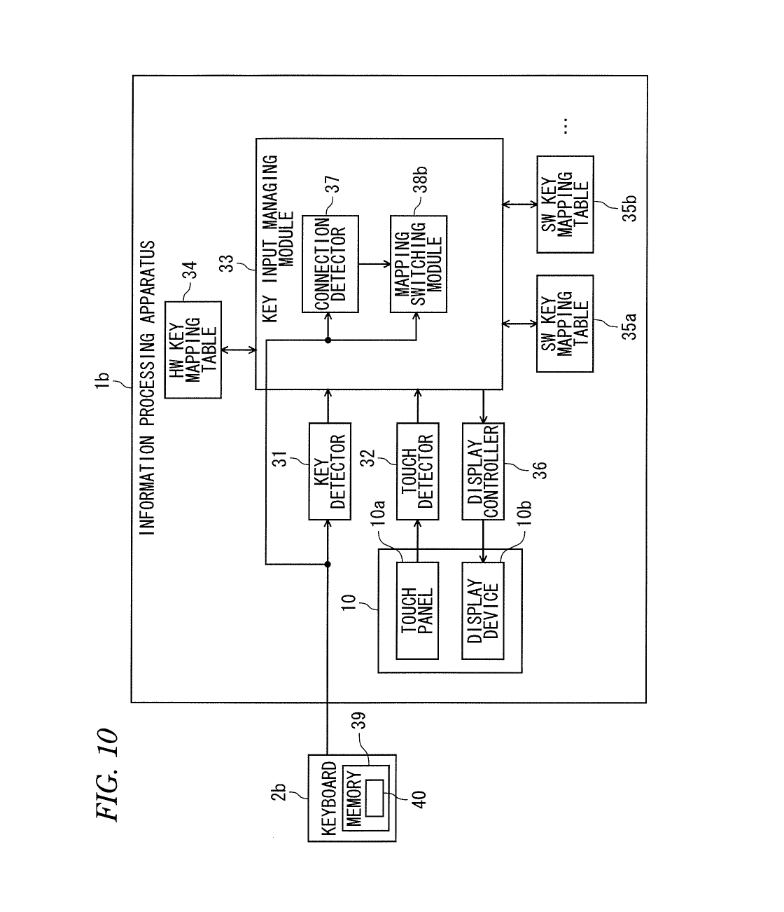

FIG. 10 shows the electrical configuration of an information processing apparatus 1b according to the third embodiment. Sections etc. shown in FIG. 10 having the same ones in FIG. 3 are given the same reference symbols as the latter, and will not be described in detail.

As shown in FIG. 10, the information processing apparatus 1b according to the third embodiment has a mapping switching module 38b in place of the mapping switching module 38 used in the first embodiment. Furthermore, a keyboard 2b to be connected to the information processing apparatus 1b is equipped with a memory 39 which is stored with an SW key mapping table 40 for generation of SW keys 11.

More specifically, the SW key mapping table 40 contains an SW key mapping table for displaying, on the touch screen 10, keys that are not provided in the keyboard 2b as HW keys 21. The SW key mapping table 40 is read out by the mapping switching module 38b when the keyboard 2b is connected to the information processing apparatus 1b.

The mapping switching module 38b switches the SW key mapping table to be referred, according to a result of detection of connection/non-connection of the keyboard 2b that is supplied from the connection detector 37. If the keyboard 2b is connected to the information processing apparatus 1b, the mapping switching module 38b switches the SW key mapping table to be referred to the SW key mapping table 40 which is stored in the memory 39 of the keyboard 2b. On the other hand, if the keyboard 2b is not connected to the information processing apparatus 1b, the mapping switching module 38b switches the SW key mapping table to be referred to one of the SW key mapping tables 35a, 35b, etc. In this case, basically, switching is made to the SW key mapping table 35b which is the keyboard non-connection table. However, switching is made to another SW key mapping table such as the SW key mapping table 35a depending on a use situation or a user.

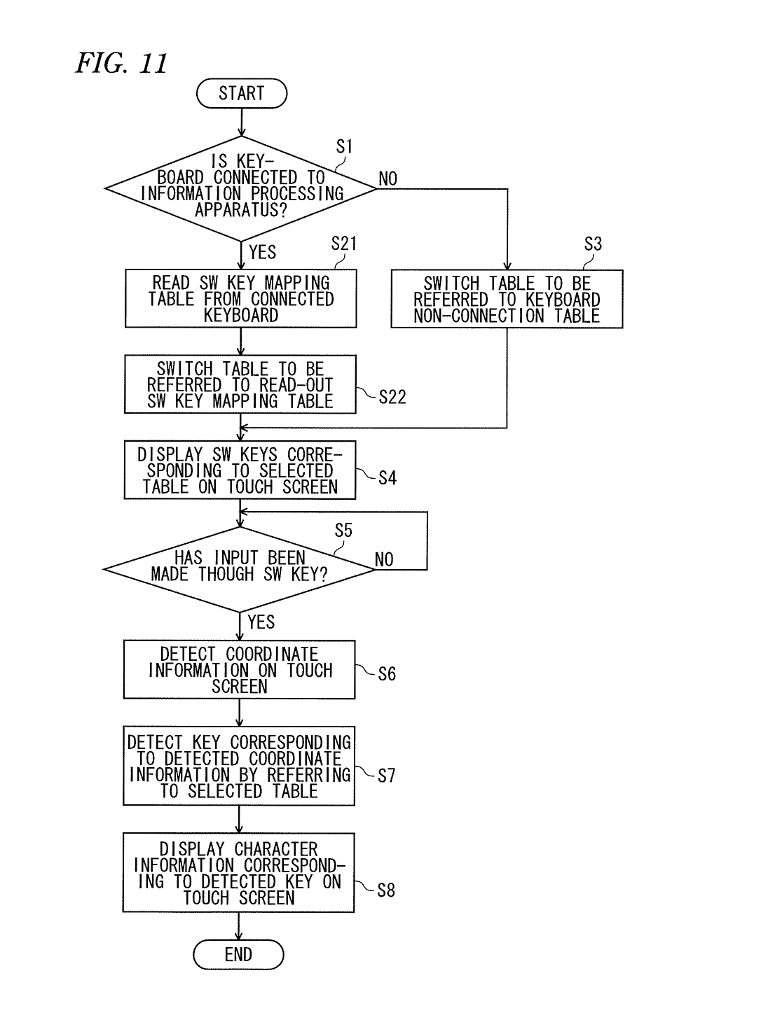

Next, a description will be made of how the above-configured information processing apparatus 1b operates. FIG. 11 is a flowchart of an SW key mapping table switching process. Steps shown in FIG. 11 that have the same steps in FIG. 6 are given the same reference symbols as the latter, and will not be described in detail.

If it is detected that a keyboard 2b is connected to the information processing apparatus 1b (S1: yes), at step S21 the mapping switching module 38b reads the SW key mapping table 40 from the connected keyboard 2b. At step S22, the mapping switching module 38b switches the SW key mapping table to be referred to the read-out SW key mapping table 40. The other steps S3-S8 are the same as in the process of FIG. 6.

As described above, when the keyboard 2b is connected to the information processing apparatus 1b, the information processing apparatus 1b reads the SW key mapping table 40 from the connected keyboard 2b and displays SW keys 11 on the touch screen 10 on the basis of the read-out SW key mapping table 40. The SW key mapping table 40 is an SW key mapping table for displaying, on the touch screen 10, keys that are not provided in the keyboard 2b as HW keys 21. As a result, the information processing apparatus 1b according to this embodiment can display, on the touch screen 10, according to a type of a connected keyboard 2b, optimum SW keys 11, that is, only keys that are not provided in the keyboard 2b as HW keys 21.

All or part of a program for causing each of the above-described operations is recorded or stored as a computer program product in, for example, a portable medium such as a flexible disk or a CD-ROM, a storage device such as a hard disk drive. The program is read by a computer, whereby all or part of the operation is performed. Alternatively, all or part of the program may be delivered or provided over a communication network. A user can easily implement the information processing apparatus or the control method according to each embodiment by downloading the program over a communication network and installing it in a computer or installing the program in a computer from a recording medium.

The steps of each of the flowcharts described in this specification may be executed in different order than shown in the flowchart or in different order each time they are executed, and part of them may be executed simultaneously as long as the intended operation is attained.

Although the several embodiments of the invention have been described above, they are just examples and should not be construed as restricting the scope of the invention. Each of these novel embodiments may be practiced in other various forms, and part of it may be omitted, replaced by other elements, or changed in various manners without departing from the spirit and scope of the invention. These modifications are also included in the invention as claimed and its equivalents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display;
a touch panel provided on the display;
a storage configured to store a plurality of kinds of software key arrangement information;
a connection detector configured to detect whether or not an input device in which mechanical keys are arranged is connected, and to output a connection detection result; and
a controller configured to determine arrangement information to be used among the plurality of kinds of software key arrangement information according to the connection detection result which is output from the connection detector, and to cause the display to display software keys based on the determined arrangement information.

2. The information processing apparatus of claim 1, wherein
when a connection of an input device is detected, the connection detector detects a type of the input device, and
the controller determines arrangement information to be used among the plurality of kinds of software key arrangement information further according to the type of the input device detected by the connection detector, and causes the display to display software keys based on the determined arrangement information.

3. The information processing apparatus of claim 1, wherein
when a connection of an input device is detected, the controller reads arrangement information stored in the input device, employs the read-out arrangement information as arrangement information to be used, and causes the display to display software keys based on the employed arrangement information.

4. A control method of an information processing apparatus comprising:
detecting whether or not an input device in which mechanical keys are arranged is connected;
outputting a connection detection result;
determining arrangement information to be used among a plurality of kinds of software key arrangement information stored in a storage according to the output connection detection result; and
causing a display to display software keys based on the determined arrangement information.

5. The control method of an information processing apparatus of claim 4, further comprising:
detecting a type of an input device when a connection of the input device is detected;
determining arrangement information to be used among the plurality of kinds of software key arrangement information further according to the detected type of the input device; and
causing the display to display software keys based on the determined arrangement information.

6. The control method of an information processing apparatus of claim 4, further comprising:
reading arrangement information stored in an input device when a connection of the input device is detected;
employing the read-out arrangement information as arrangement information to be used; and
causing the display to display software keys based on the employed arrangement information.

7. A non-transitory computer-readable medium storing a program that causes a computer to execute information processing comprising:
detecting whether or not an input device in which mechanical keys are arranged is connected;
outputting a connection detection result;
determining arrangement information to be used among a plurality of kinds of software key arrangement information stored in a storage according to the output connection detection result; and
causing a display to display software keys based on the determined arrangement information.

8. The computer-readable medium of claim 7, further comprising:
detecting a type of an input device when a connection of the input device is detected;
determining arrangement information to be used among the plurality of kinds of software key arrangement information further according to the detected type of the input device; and
causing the display to display software keys based on the determined arrangement information.

9. The computer-readable medium of claim 7, further comprising:
reading arrangement information stored in an input device when a connection of the input device is detected;
employing the read-out arrangement information as arrangement information to be used; and
causing the display to display software keys based on the employed arrangement information.
